(19) United States
(12) Patent Application Publication
(10) Pub. No.: US 2026/0135398 A1
(43) Pub. Date: May 14, 2026

(54) CHARGING AND DISCHARGING DEVICE

(71) Applicant: SK On Co., Ltd., Seoul (KR)

(72) Inventors: Chang Mook HWANG, Daejeon (KR); Hyun Ji KIM, Daejeon (KR); Chul Ho KANG, Daejeon (KR); Ha Neul SONG, Daejeon (KR)

(21) Appl. No.: 19/387,636

(22) Filed: Nov. 13, 2025

(30) Foreign Application Priority Data
Nov. 13, 2024 (KR) 10-2024-0161111

(51) Int. Cl. H02J 7/00

(52) U.S. Cl. CPC H02J 7/60; H02J 7/80

(57) ABSTRACT

The present disclosure relates to a charging and discharging device comprising: a sensing portion obtaining a status information of a battery cell, and a controller determining whether the battery cell is abnormal using the status information, wherein the controller determines whether the battery cell is abnormal based on comparing a first status information of the battery cell obtained in the N−1th, where N is a natural number of 2 or more, charging cycle of the battery cell and a second status information of the battery cell obtained in the Nth charging cycle following the N−1th charging cycle of the battery cell.

### CROSS-REFERENCE TO RELATED PATENT APPLICATION

The present application claims priority under 35 U.S.C. § 119a to Korean patent application number 10-2024-0161111 filed on Nov. 13, 2024, in the Korean Intellectual Property Office, the entire disclosure of which is incorporated by reference herein.

### BACKGROUND OF THE DISCLOSURE

### 1. Field

The present disclosure relates to a charging and discharging device. More specifically, it relates to a device for detecting abnormalities in battery cells.

### 2. Description of the Related Art

The working principle of a lithium rechargeable battery is an electrochemical oxidation-reduction reaction, i.e., the movement of lithium ions to generate electricity and vice versa. In the case of a lithium secondary battery, the phenomenon of lithium ions escaping from an anode and going to a cathode through the electrolyte and separator is called discharge. The opposite process is called charging.

However, recent fires and explosions involving lithium rechargeable batteries have raised public concerns about the safety of battery use. Specifically, batteries can suffer from thermal runaway, which can lead to ignition and explosion, due to various issues such as overcharging, over discharging, and shorting between terminals.

Previously, the focus has been on suppressing and resolving thermal runaway in batteries after it occurs, but there is no system in place to proactively detect the danger of a battery cell and issue a danger alert.

According to one aspect of the present disclosure, the problem is to improve the reliability of battery cells.

According to another aspect of the present disclosure, the problem is to prevent fires in battery cells.

According to another aspect of the present disclosure, it is addressed to notify a user of an abnormality in a battery cell.

The charging and discharging device according to the present disclosure can be widely applied in the fields of electric vehicles, battery charging stations, energy storage systems, and other green technologies such as photovoltaics and wind power utilizing battery cells. Furthermore, the charge and discharge device according to the present disclosure can be used in eco-friendly mobility, including electric vehicles and hybrid vehicles to prevent climate change by suppressing air pollution and greenhouse fluid emissions.

### SUMMARY OF THE DISCLOSURE

A charging and discharging device according to an embodiment of the present disclosure may comprise: a sensing portion obtaining a status information of a battery cell, and a controller determining whether the battery cell is abnormal using the status information, wherein the controller determines whether the battery cell is abnormal based on comparing a first status information of the battery cell obtained in the N−1th, where N is a natural number of 2 or more, charging cycle of the battery cell and a second status information of the battery cell obtained in the Nth charging cycle following the N−1th charging cycle of the battery cell.

In an embodiment, the first status information may include a first sensing value for at least one of voltage, current, temperature, or capacity of the battery cell, and the second status information may include a second sensing value for at least one of voltage, current, temperature, or capacity of the battery cell.

In an embodiment, the controller may determine whether the battery cell is abnormal based on comparing the first sensing value indicating the highest temperature of the battery cell obtained in the N−1th charging cycle and the second sensing value indicating the highest temperature of the battery cell obtained in the Nth charging cycle.

In an embodiment, each of the N−1th charging cycle and the Nth charging cycle may include a section based on a constant current mode and a section based on a constant voltage mode.

In an embodiment, the controller may determine whether the battery cell is abnormal based on comparing the first sensing value indicating the capacity of the battery cell obtained in the section based on the constant current mode during the N−1th charging cycle and the second sensing value indicating the capacity of the battery cell obtained in the section based on the constant current mode during the Nth charging cycle.

In an embodiment, the controller may determine whether the battery cell is abnormal based on comparing the first sensing value indicating the capacity of the battery cell obtained in the section based on the constant voltage mode during the N−1th charging cycle and the second sensing value indicating the capacity of the battery cell obtained in the section based on the constant voltage mode during the Nth charging cycle.

In an embodiment, the controller may determine whether the battery cell is abnormal based on comparing a first time indicating a time between the start time and the end time of the section based on the constant voltage mode during the N−1th charging cycle and a second time indicating a time between the start time and the end time of the section based on the constant voltage mode during the Nth charging cycle.

In an embodiment, the controller may determine whether the battery cell is abnormal based on comparing the first sensing value indicating the highest temperature of the battery cell obtained in the section based on the constant current mode during the N−1th charging cycle and the second sensing value indicating the highest temperature of the battery cell obtained in the section based on the constant current mode during the Nth charging cycle.

In an embodiment, the controller may determine whether the battery cell is abnormal based on a change in current of the battery cell obtained in the section based on the constant current mode during the Nth charging cycle.

In an embodiment, the controller may determine whether the battery cell is abnormal based on a change in voltage of the battery cell obtained in the Nth charging cycle.

In an embodiment, the controller may determine that the battery cell is abnormal if the second sensing value indicating the voltage of the battery cell obtained in the Nth charging cycle is not included in a value between a predetermined first value and a predetermined second value greater than the predetermined first value.

In an embodiment, the charging and discharging device may further comprise: a communicating portion transmitting information indicating an abnormality in the battery cell to an external electronic device, and wherein the controller, if it determines that the battery cell is abnormal, transmits a control signal to the external electronic device via the communicating portion, causing the external electronic device to output information indicating that the battery cell is abnormal.

A charging and discharging device according to another embodiment of the present disclosure may comprise: a sensing portion obtaining a status information of a battery cell, and a controller determining whether the battery cell is abnormal using the status information, wherein the controller determines whether the battery cell is abnormal based on comparing a third status information of the battery cell obtained in the N−1th, where N is a natural number of 2 or more, discharging cycle of the battery cell and a fourth status information of the battery cell obtained in the Nth discharging cycle following the N−1th discharging cycle of the battery cell.

In another embodiment, the controller may determine whether the battery cell is abnormal based on comparing a third sensing value indicating a capacity of the battery cell obtained in a section based on the constant current mode during the N−1th discharging cycle and a fourth sensing value indicating a capacity of the battery cell obtained in a section based on the constant current mode during the Nth charging cycle.

In another embodiment, the controller may determine whether the battery cell is abnormal based on a change in voltage of the battery cell obtained in the Nth discharging cycle.

According to one embodiment of the present disclosure, the stability of a battery cell can be improved.

According to another embodiment of the present disclosure, a fire of a battery cell can be prevented.

According to another embodiment of the present disclosure, a user can be notified of an abnormality of the battery cell.

### BRIEF DESCRIPTION OF THE DRAWINGS

FIG. 1 is a block diagram illustrating a battery monitoring system including a charging and discharging device and an external device according to the present disclosure.

FIG. 2 is a diagram illustrating a process for manufacturing a battery cell.

FIG. 3 is a flow diagram illustrating how a charging and discharging device according to the present disclosure detects an abnormality of a battery cell based on status information of the battery cell obtained from a charging cycle.

FIGS. 4 and 5 are flow diagrams illustrating how a charging and discharging device according to the present disclosure detects an abnormality of a battery cell based on temperature.

FIG. 6 is a flow diagram illustrating how a charging and discharging device according to the present disclosure detects an abnormality of a battery cell based on a capacity of the battery cell.

FIG. 7 is a flow diagram illustrating how a charging and discharging device according to the present disclosure detects an abnormality of a battery cell based on a start time and an end time of a charging cycle.

FIG. 8 is a flow diagram illustrating how a charging and discharging device according to the present disclosure detects an abnormality of a battery cell based on a change in current.

FIG. 9 is a flow diagram illustrating how a charging and discharging device according to the present disclosure detects an abnormality of a battery cell based on a change in voltage of the battery cell.

FIG. 10 is a flow diagram illustrating how a charging and discharging device according to the present disclosure detects an abnormality of a battery cell based on a voltage of the battery cell.

FIG. 11 is a flow diagram illustrating how a charging and discharging device according to the present disclosure detects an abnormality of a battery cell based on status information of the battery cell obtained in a discharging cycle.

FIG. 12 is a flow diagram illustrating how a charging and discharging device according to the present disclosure detects an abnormality of a battery cell based on a capacity of the battery cell.

FIG. 13 is a flow diagram illustrating how a charging and discharging device according to the present disclosure detects an abnormality of a battery cell based on a change in voltage of the battery cell.

FIG. 14 is a flow diagram illustrating how a charging and discharging device according to the present disclosure detects an abnormality of a battery cell based on a voltage of the battery cell.

### DETAILED DESCRIPTION

Hereinafter, preferred embodiments of the present disclosure will be described in detail with reference to the accompanying drawings. The configuration of the apparatus or control method described below is for the purpose of illustrating embodiments of the present disclosure and is not intended to limit the scope of the present disclosure, and like reference numerals used throughout the description refer to like components.

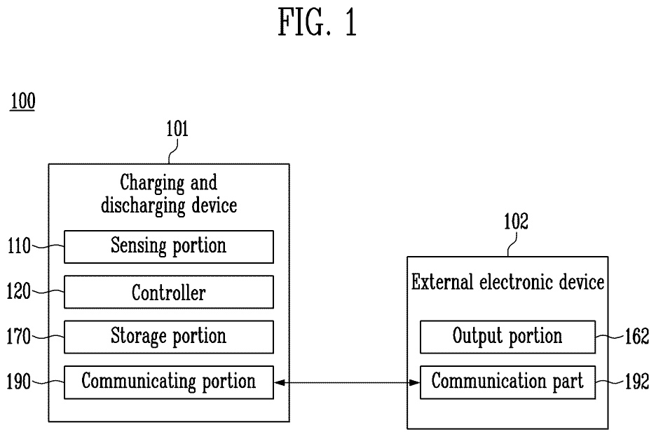

FIG. 1 is a block diagram illustrating a battery monitoring system including a charging and discharging device and an external device according to the present disclosure.

Referring to FIG. 1, a battery monitoring system 100 according to the present disclosure may include a charging and discharging device 101 and an external electronic device 102. The battery monitoring system 100 may represent a system for detecting whether a battery cell is abnormal by the charging and discharging device 101 and outputting information indicating that the battery cell has an abnormality by the external electronic device 102.

The battery cell may be repeatedly subjected to a charging cycle and a discharging cycle in a single cycle. For example, the charging cycle may include a section based on a constant current mode and a section based on a constant voltage mode. In an example, the discharging cycle may include a section based on a constant current mode and a section based on a constant voltage mode.

For example, a charging cycle may represent a time section from when a battery cell begins charging to when the battery cell reaches a status of full charge by charging. For example, a discharging cycle may represent a time section from when the battery cell begins discharging to when the battery cell reaches a fully discharged status after a charging cycle is complete.

The charging and discharging device 101 may detect whether the battery cell is abnormal by comparing the status information of the battery cell in the Nth charging cycle of the battery cell, where N is a natural number of 2 or more, with the status information of the battery cell in the N−1th charging cycle, which represents the cycle immediately preceding the Nth charging cycle of the battery cell. The charging and discharging device 101 may detect whether the battery cell is abnormal by comparing the status information of the battery cell in the Nth discharging cycle of the battery cell, where N is a natural number of 2 or more, with the status information of the battery cell in the N−1th discharging cycle, which represents the cycle immediately preceding the Nth discharging cycle of the battery cell.

If the charging and discharging device 101 determines that the battery cell is abnormal, the charging and discharging device 101 may transmit information indicating that there is an abnormality of the battery cell to the external electronic device 102. For example, the information indicating that the battery cell is abnormal may include information that the battery cell is short-circuited due to leakage current. The information indicating that the battery cell is abnormal may further include a command signal causing the external electronic device 102 to output the information indicating that the battery cell is abnormal. The external electronic device 102 can receive information indicating that the battery cell is abnormal from a charging and discharging device 101 and output information indicating that the battery cell is abnormal.

The external electronic device 102 may be implemented as a smartphone, computing device, tablet PC, or wearable electronic device that can be worn on a user's body. However, this is an example, and the external electronic device 102 according to the present disclosure can be implemented as a variety of devices capable of outputting information indicating an abnormality in the battery cell by voice, haptic, or visual means.

The external electronic device 102 may include a communication part 192 and an output portion 162. The communication part 192 may obtain information from the charging and discharging device 101. The output portion 162 may output information received from the charging and discharging device 101. For example, the output portion 162 may be implemented as a display, or a speaker. For example, the external electronics device 102 may output information as a pop-up window, icon, thumbnail, or indicator indicating an abnormality in the battery cell.

The charging and discharging device 101 may be implemented as a battery management system (BMS) device. However, this is an example, and the charging and discharging device 101 according to the present disclosure may be implemented as a variety of devices capable of sensing status information of a battery cell and monitoring the battery cell for abnormalities.

The charging and discharging device 101 may include a sensing portion 110, a controller 120, a storage portion 170, and a communicating portion 190.

The sensing portion 110 may obtain status information of the battery cells at a specified time. For example, the specified time may be set by a user, automatically set by the controller 120, or preset during the manufacturing of the charging and discharging device 101. According to one embodiment, the battery cell status information may include sensing values for current, voltage, temperature, and/or capacity of the battery cell. The sensing portion 110 may include a sensor capable of sensing the current, voltage, temperature, and/or capacity of the battery cell.

The communicating portion 190 may be in communication with the external electronic device 102. The communicating portion 190 may transmit abnormal information of the battery cells to the external electronic device 102.

The controller 120, if it determines that the battery cell is abnormal, may transmit a control signal to the external electronic device 102 via the communicating portion 190, causing the external electronic device 102 to output information indicating that the battery cell is abnormal.

The controller 120 may control the overall operation of the charging and discharging device 101. The controller 120 may be implemented as a central processing unit (CPU). The storage part 170 may store the status information of the battery cells obtained

through the sensing portion 110. The storage portion 170 may be implemented as a memory. For example, the memory may be implemented as a non-volatile memory or a volatile memory.

The charging and discharging device 101 according to the present disclosure may further include an output portion. The charging and discharging device 101 may output abnormality status information of the battery cell via the output portion.

The battery monitoring system 100 according to the present disclosure may further comprise a separate server. In FIG. 1, the charging and discharging device 101 is shown communicating directly with the external electronic device 102, but the charging and discharging device 101 and the external electronic device 102 may also communicate through a separate server.

The charging and discharging device 101 comprising: the sensing portion 110 obtaining a status information of the battery cell; and the controller 120 determining whether the battery cell is abnormal using the status information, wherein the controller 120 may determine whether the battery cell is abnormal based on comparing a first status information of the battery cell obtained in the N−1th, where N is a natural number of 2 or more, charging cycle of the battery cell and a second status information of the battery cell obtained in the Nth charging cycle following the N−1th charging cycle of the battery cell. The first status information includes a first sensing value for at least one of voltage, current, temperature, or capacity of the battery cell, and the second status information includes a second sensing value for at least one of voltage, current, temperature, or capacity of the battery cell. Hereinafter, operations of the controller 120 to detect an abnormality of the battery

cell based on a temperature of the battery cell obtained during a charging cycle of the battery cell will be described.

Each of the N−1th charging cycle and the Nth charging cycle includes a section based on a constant current mode and a section based on a constant voltage mode.

The controller 120 may determine whether the battery cell is abnormal based on comparing the first sensing value indicating the highest temperature of the battery cell obtained in the N−1th charging cycle and the second sensing value indicating the highest temperature of the battery cell obtained in the Nth charging cycle.

The controller 120 may determine whether the battery cell is abnormal based on comparing the first sensing value indicating the highest temperature of the battery cell obtained in the section based on the constant current mode during the N−1th charging cycle and the second sensing value indicating the highest temperature of the battery cell obtained in the section based on the constant current mode during the Nth charging cycle.

According to one embodiment, the controller 120 may determine that the battery cell has an abnormality if the magnitude of a difference between a sensing value indicating the highest temperature of the battery cell obtained in the N−1thst charging cycle stored in the storage portion 170 and a sensing value indicating the highest temperature of the battery cell obtained in the Nth charging cycle stored in the storage portion 170 is determined to be greater than a threshold value. For example, the threshold value may be 10 days, but the number set as the threshold value may not be limited thereto. The threshold value may indicate a value associated with a temperature above which the battery cell is determined to be abnormal. The threshold value may be set by a user, automatically set by the controller 120, or set during the manufacturing of the charging and discharging device 101.

According to one embodiment, the controller 120 may determine that the battery cell has an abnormality if the difference between the sensing value indicating the highest temperature of the battery cell obtained during the section of the constant current mode of the N−1th charging cycle and the sensing value indicating the highest temperature of the battery cell obtained during the constant current mode of the Nth charging cycle is determined to be greater than the threshold value.

Hereinafter, an operation of the controller 120 detecting an abnormality of the battery cell based on a capacity of the battery cell determined from a charging cycle of the battery cell will be described.

The controller 120 may determine whether the battery cell is abnormal based on comparing the first sensing value indicating the capacity of the battery cell obtained in the section based on the constant current mode during the N−1th charging cycle and the second sensing value indicating the capacity of the battery cell obtained in the section based on the constant current mode during the Nth charging cycle.

The controller 120 may determine whether the battery cell is abnormal based on comparing the first sensing value indicating the capacity of the battery cell obtained in the section based on the constant voltage mode during the N−1th charging cycle and the second sensing value indicating the capacity of the battery cell obtained in the section based on the constant voltage mode during the Nth charging cycle.

According to one embodiment, the controller 120 may determine that there is an abnormality in the battery cell if it is confirmed that the rate at which the sensing value indicating a capacity of the battery cell obtained in the section based on the constant current mode during the Nth charging cycle increases is greater than a threshold value based on the sensing value indicating a capacity of the battery cell obtained in the section based on the constant current mode during the N−1th charging cycle. For example, the threshold may be 5, but the number set as the threshold may not be limited thereto. The threshold value may indicate a value associated with a percentage value at which the battery cell is determined to be abnormal. The threshold value may be set by a user, or may be set automatically by the controller 120.

According to one embodiment, the controller 120 may determine that there is an abnormality in the battery cell, based on the sensing value indicating a capacity of the battery cell obtained during the section based on the constant voltage mode during the N−1th charging cycle, if the rate increase in the sensing value indicating the capacity of the battery cell obtained during the section based on the constant voltage mode during the Nth charging cycle is determined to be greater than a threshold value.

In the following, operations of the controller 120 to detect an abnormality of the battery cell based on a time section of a charging cycle of the battery cell will be described.

The controller 120 may determine whether the battery cell is abnormal based on comparing a first time indicating a time between the start time and the end time of the section based on the constant voltage mode during the N−1th charging cycle and a second time indicating a time between the start time and the end time of the section based on the constant voltage mode during the Nth charging cycle.

According to one embodiment, the controller 120 may determine that there is an abnormality in the battery cell if the difference between a first time indicating a time between a start time of the constant voltage mode and an end time of the constant voltage mode during the N−1th charging cycle and a second time indicating a time between a start time of the constant voltage mode and an end time of the constant voltage mode included in the Nth charging cycle is determined to be greater than a threshold value. For example, the threshold value may be 5, but the number set as the threshold value may not be limited thereto. The threshold value may indicate a value associated with a percentage value at which the battery cell is determined to be abnormal. The threshold value may be set by a user, or may be set automatically by the controller 120.

In the following, operations of the controller 120 to detect an abnormality of the battery cell based on a change in the current of the battery cell obtained during a charging cycle of the battery cell will be described.

The controller 120 may determine whether the battery cell is abnormal based on a change in current of the battery cell obtained in the section based on the constant current mode during the Nth charging cycle.

The controller 120 may obtain a change in current over a specified time period in the constant voltage mode of the Nth charging cycle. If the controller 120 determines that the change in current over the specified time period is greater than a threshold value, the controller 120 may determine that the battery cell is abnormal. For example, the threshold value may be 0.12. The threshold value may indicate a value at which the current is determined to change rapidly in the constant voltage mode of the charging cycle.

In the following, the operation of the controller 120 to detect an abnormality of the battery cell based on a change in the voltage of the battery cell obtained during the charging cycle of the battery cell will be described.

The controller 120 may determine whether the battery cell is abnormal based on a change in voltage of the battery cell obtained in the Nth charging cycle.

According to one embodiment, the controller 120 may obtain the change in voltage over a specified time period in the Nth charging cycle. The controller 120 may determine that the battery cell is abnormal if the change in voltage over the specified time period is determined to be greater than a threshold value. The threshold value may indicate a value at which the voltage is determined to change rapidly in a charging cycle. For example, the threshold value may be 200×10⁻³.

In the following, operations of the controller 120 to detect an abnormality of a battery cell based on a voltage of the battery cell obtained during a charging or discharging cycle of the battery cell will be described.

The controller 120 may determine that the battery cell is abnormal if the second sensing value indicating the voltage of the battery cell obtained in the Nth charging cycle is not included in a value between a predetermined first value and a predetermined second value greater than the predetermined first value.

According to one embodiment, the controller 120 may determine that the battery cell is abnormal if the sensing value indicating the voltage of the battery cell is determined not to be included in a value between the predetermined first value and the predetermined second value that is greater than the predetermined first value. The predetermined first value may indicate a lower limit value for the voltage at which the battery cell is determined not to be abnormal, and the predetermined second value may indicate an upper limit value for the voltage at which the battery cell is determined not to be abnormal. For example, the predetermined first value may indicate 1.9 and the predetermined second value may indicate 4.4. The predetermined first value and the predetermined second value may be set by a user, automatically set by the controller 120, or set during manufacturing of the charging and discharging device 101.

Hereinafter, operations of the controller 120 to detect an abnormality of a battery cell based on a capacity of the battery cell as confirmed from a discharging cycle of the battery cell will be described.

The charging and discharging device 101 comprising: the sensing portion 110 obtaining a status information of the battery cell; and a controller 120 determining whether the battery cell is abnormal using the status information, wherein the controller 120 may determine whether the battery cell is abnormal based on comparing a third status information of the battery cell obtained in the N−1th, where N is a natural number of 2 or more, discharging cycle of the battery cell and a fourth status information of the battery cell obtained in the Nth discharging cycle following the N−1th discharging cycle of the battery cell. The controller 120 may determine whether the battery cell is abnormal based on comparing a third sensing value indicating a capacity of the battery cell obtained in a section based on the constant current mode during the N−1th discharging cycle and a fourth sensing value indicating a capacity of the battery cell obtained in a section based on the constant current mode during the Nth charging cycle.

According to one embodiment, the controller 120 may determine that the battery cell has an abnormality, based on the capacity of the battery cell obtained in the section of the constant current mode of the N−1th discharging cycle, if a rate of the increase in the capacity of the battery cell obtained in the section of the constant current mode of the second N−1 discharging cycle is greater than a threshold value. For example, the threshold value may be 5, but the number set as the threshold value may not be limited thereto. The threshold value may indicate a value associated with a rate value at which the battery cell is determined to be abnormal.

In the following, operations of the controller 120 to detect an abnormality of the battery cell based on a change in the voltage of the battery cell obtained during a discharging cycle of the battery cell will be described.

The controller 120 may determine whether the battery cell is abnormal based on a change in voltage of the battery cell obtained in the Nth discharging cycle.

According to one embodiment, the controller 120 may obtain a change in voltage over a specified time in the Nth discharging cycle. For example, the specified time may be 0.1 seconds. If the controller 120 determines that the change in voltage is greater than a threshold value, the controller 120 may determine that the battery cell is abnormal. The threshold value may indicate a value at which the voltage is determined to change rapidly in a discharging cycle. For example, the threshold may be 200×10⁻³. However, this is an example, and the threshold value of the present disclosure may be set at various values.

The charging and discharging device 101 according to the present disclosure may stop charging and discharging operations of the battery cell when it is determined that the battery cell is abnormal. The charging and discharging device 101 may also stop obtaining the status information of the battery cell via the sensing portion 110 at a specified time when it is confirmed that there is an abnormality in the battery cell.

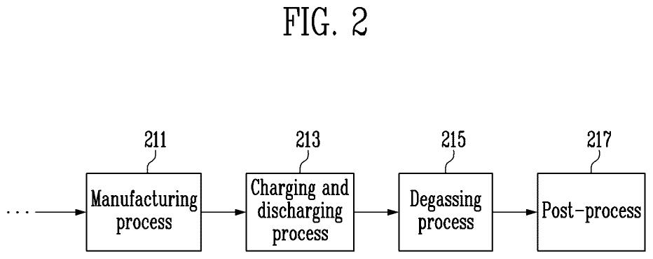

FIG. 2 is a diagram illustrating a process for manufacturing a battery cell.

Referring to FIG. 2, a process for manufacturing a battery cell may include a manufacturing process 211, a charging and discharging process 213 for charging and discharging the battery cell, a degassing process 215 for removing gases generated in the battery cell, and a post-process 217 related to a quality inspection process after the degassing process 215.

According to one embodiment, the operation of the charging and discharging device 101 according to the present disclosure to detect whether the battery cell is abnormal based on the status information of the battery cell obtained in the charging cycle and the discharging cycle may be performed in the charge and discharge process 213. According to one embodiment, the operation of detecting whether the battery cell is abnormal based on the status information of the battery cell obtained in the charging cycle and the discharging cycle by the charging and discharging device 101 according to the present disclosure may be performed in the post-process 217.

Hereinafter, for ease of explanation, the operations performed by the controller 120 will be described as operations performed by the charging and discharging device 101.

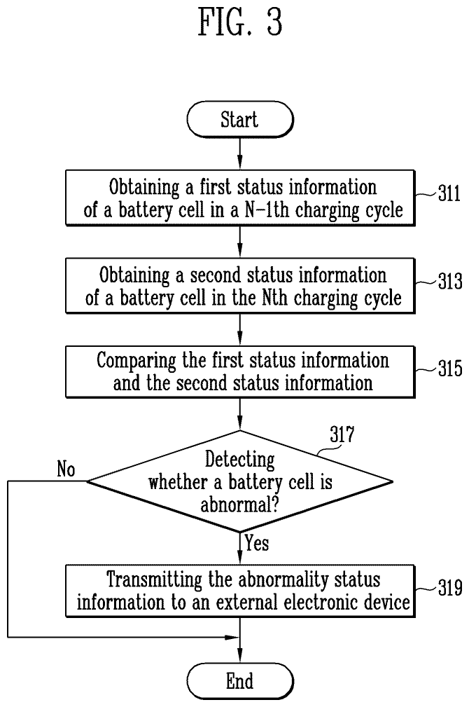

FIG. 3 is a flow diagram illustrating how a charging and discharging device according to the present disclosure detects an abnormality of a battery cell based on status information of the battery cell obtained from a charging cycle.

Referring to FIG. 3, according to one embodiment, in operation 311, the charging and discharging device 101 may obtain, via the sensing portion 110, a first status information of the battery cell in a N−1th charging cycle. According to one embodiment, N may represent a natural number of 2 or more. For example, the first status information may include a sensing value for any one of voltage, current, temperature, or capacity of the battery cell.

According to one embodiment, in operation 313, the charging and discharging device 101 may obtain, via the sensing portion 110, a second status information of the battery cell in the Nth charging cycle. For example, the second status information may include a sensing value for any one of voltage, current, temperature, or capacity of the battery cell.

According to one embodiment, in operation 315, the charging and discharging device 101 may compare the first status information to the second status information.

According to one embodiment, in operation 317, the charging and discharging device 101 may determine, based on comparing the first status information and the second status information, whether the battery cell is abnormal. For example, the charging and discharging device 101 may determine whether an abnormality has been detected in the battery cell based on a difference between a first sensing value included in the first status information and a second sensing value included in the second status information. For example, the charging and discharging device 101 may determine whether the battery cell is abnormal based on a rate of increase in the second sensing value included in the second status information relative to the first sensing value included in the first status information.

According to one embodiment, in operation 319, if the charging and discharging device 101 determines that an abnormality has been detected in the battery cell (“Yes” in operation 317), the charging and discharging device 101 may transmit the abnormality status information for the battery cell to the external electronic device 102 via the communicating portion 190. The abnormal information may include information indicating that an abnormality has occurred in the battery cell. The abnormal information may further include a command signal causing the external electronic device 102 to output the abnormal information. According to one embodiment, the charging and discharging device 101 may stop charging and discharging operations of the battery cell when it is determined that an abnormality is detected in the battery cell. The charging and discharging device 101 may also stop the operation of obtaining the status information of the battery cell every specified time via the sensing portion 110 when it is determined that there is an abnormality in the battery cell.

According to one embodiment, the external electronic device 102 may receive the abnormal information from the charging and discharging device 101 via the communication part 192. According to one embodiment, the external electronic device 102 may output the abnormal information via the output portion 162. For example, the external electronic device 102 may output the abnormal information via visual means, audible means, and/or tactile means (e.g., haptic).

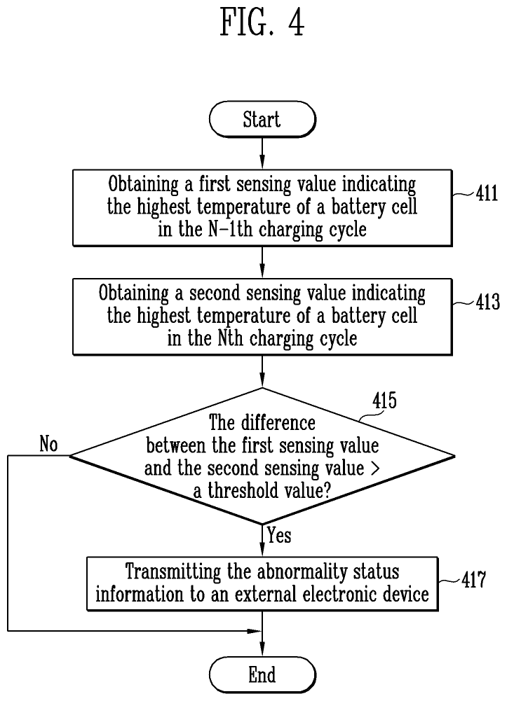

FIG. 4 is a flow diagram illustrating how a charging and discharging device according to the present disclosure detects an abnormality of a battery cell based on temperature.

Referring to FIG. 4, according to one embodiment, in operation 411, the charging and discharging device 101 may obtain a first sensing value indicating the highest temperature of the battery cell in the N−1th charging cycle. For example, the charging and discharging device 101 may obtain sensing data indicating the temperature of the battery cell at specified times during the N−1th charging cycle and store the sensing data in the storage portion 170. The charging and discharging device 101 may determine a first sensing value indicating the highest temperature among the sensing data indicating the temperature of the battery cell stored in the storage portion 170. For example, the specified time may be set by a user, automatically set by the charging and discharging device 101 (e.g., the controller 120), or set during the manufacturing of the charging and discharging device 101.

According to one embodiment, in operation 413, the charging and discharging device 101 may obtain a second sensing value indicating the highest temperature of the battery cell in the Nth charging cycle. For example, the charging and discharging device 101 may obtain sensing data indicating the temperature of the battery cell at specified times during the Nth charging cycle and store the sensing data in the storage portion 170. The charging and discharging device 101 may determine a second sensing value indicating the highest temperature among the sensing data indicating the temperature of the battery cell stored in the storage portion 170.

According to one embodiment, in operation 415, the charging and discharging device 101 may determine whether the difference between the first sensing value and the second sensing value is greater than a threshold value. For example, the threshold value may be 10, but the number set as the threshold value may not be limited thereto. The threshold value may indicate a value associated with a temperature at which the battery cell is determined to be abnormal. The threshold value may be set by a user, automatically set by the charging and discharging device 101 (e.g., the controller 120), or set during the manufacturing of the charging and discharging device 101.

According to one embodiment, in operation 417, the charging and discharging device 101 may transmit the abnormal information of the battery cell to the external electronic device 102 via the communicating portion 190 when the difference between the first sensing value and the second sensing value is determined to be greater than the threshold value (“Yes” in operation 415). According to one embodiment, the charging and discharging device 101 may stop charging and discharging the battery cell when the difference between the first sensing value and the second sensing value is determined to be greater than a threshold value. According to one embodiment, the charging and discharging device 101 may stop the operation of obtaining the status information of the battery cell via the sensing portion 110 when it is confirmed that the difference between the first sensing value and the second sensing value is greater than the threshold value.

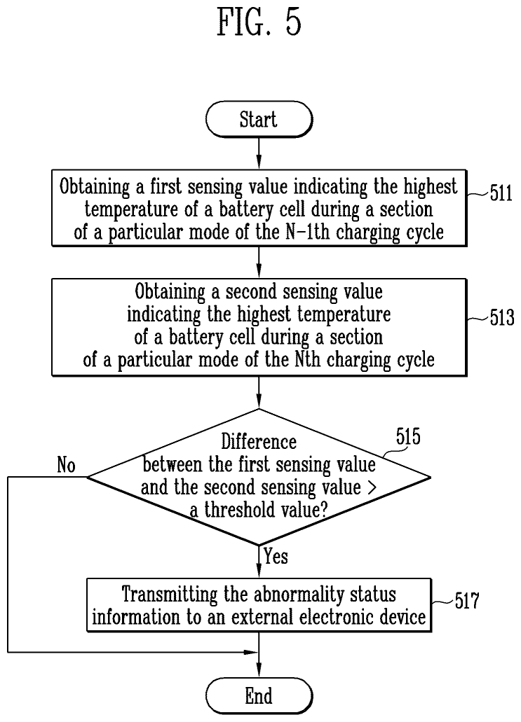

FIG. 5 is a flow diagram illustrating how a charging and discharging device according to the present disclosure detects an abnormality of a battery cell based on temperature.

Referring to FIG. 5, according to one embodiment, in operation 511, the charging and discharging device 101 may obtain a first sensing value indicating the highest temperature of the battery cell during a section of a particular mode of the N−1th charging cycle. For example, the charging cycle may include a section in a constant current mode and a section in a constant voltage mode following the section in the constant current mode. For example, a particular mode may represent a constant current mode.

According to one embodiment, in operation 513, the charging and discharging device 101 may obtain a second sensing value indicating the highest temperature of the battery cell during the section of the particular mode of the Nth charging cycle. For example, the second sensing value may indicate a sensing value indicating the highest temperature obtained during a section of the constant current mode of the charging cycle of the Nth charging cycle.

According to one embodiment, in operation 515, the charging and discharging device 101 may determine whether the difference between the first sensing value and the second sensing value is greater than a threshold value. For example, the threshold value may be 5, but the number set as the threshold value may not be limited thereto. The threshold may indicate a value associated with a temperature above which a battery cell is determined to be abnormal. The threshold value may be set by a user, automatically set by the charging and discharging device 101 (e.g., the controller 120), or set during the manufacturing of the charging and discharging device 101.

According to one embodiment, in operation 517, when the charging and discharging device 101 determines that the difference between the first sensing value and the second sensing value is greater than the threshold (“Yes” in operation 515), the charging and discharging device 101 may transmit the abnormality status information of the battery cell to the external electronic device 102 via the communicating portion 190. According to one embodiment, the charging and discharging device 101 may stop charging and discharging the battery cell when the difference between the first sensing value and the second sensing value is determined to be greater than a threshold value.

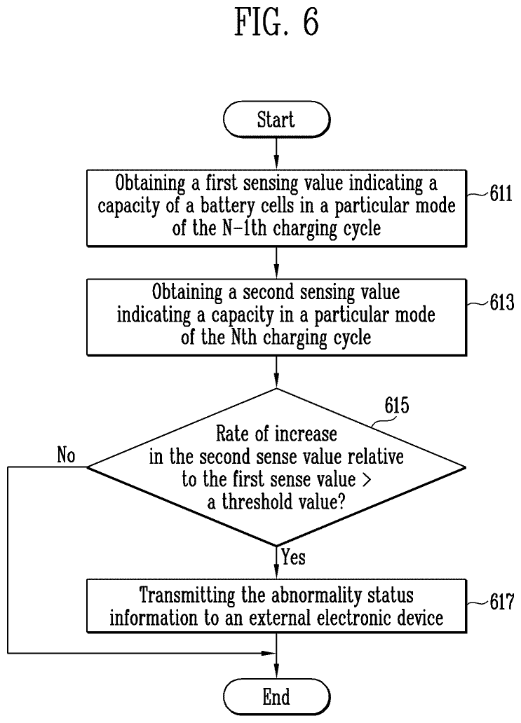

FIG. 6 is a flow diagram illustrating how a charging and discharging device according to the present disclosure detects an abnormality of a battery cell based on a capacity of the battery cell.

Referring to FIG. 6, according to one embodiment, in operation 611, the charging and discharging device 101 may obtain a first sensing value indicating the capacity of the battery cells in a particular mode of the N−1th charging cycle. For example, the charging cycle may include a section in a constant current mode and a section in a constant voltage mode following the section in the constant current mode. For example, a particular mode may represent a constant current mode or a constant voltage mode.

According to one embodiment, in operation 613, the charging and discharging device 101 may obtain a second sensing value indicating the capacity in the particular mode of the Nth charging cycle. For example, the first sensing value may be indicating the capacity obtained during a section in the constant current mode of the Nth charging cycle, and the second sensing value may be indicating the capacity obtained during a section in the constant current mode of the Nth charging cycle. Alternatively, the first sensing value may indicate a capacity obtained during a section in the constant voltage mode of the N−1th charging cycle and the second sensing value may indicate a capacity obtained during a section in the constant voltage mode of the Nth charging cycle.

According to one embodiment, in operation 615, the charging and discharging device 101 may determine whether the rate of increase in the second sensing value relative to the first sensing value is greater than a threshold value. For example, the threshold value may be 5, but the number set as the threshold value may not be limited. The threshold may indicate a value associated with a rate value above which a battery cell is determined to be abnormal. The threshold value may be set by a user, or may be set automatically by the charging and discharging device 101 (e.g., the controller 120).

According to one embodiment, the rate (%) by which the second sensing value is increased relative to the first sensing value may be defined by Equation 1 below.

$$rate = \frac{second sensing value - first sensing value}{first sensing value} \times 100 \qquad [ Equation 1 ]$$

According to one embodiment, in operation 617, the charging and discharging device 101 may transmit the abnormality status information of the battery cell to the external electronic device 102 via the communicating portion 190 when the rate of the increase in the second sensing value relative to the first sensing value is determined to be greater than a threshold value (“Yes” in operation 615). According to one embodiment, the charging and discharging device 101 may stop charging and discharging operations of the battery cell when it is determined that the rate of increase in the second sensing value relative to the first sensing value is greater than a threshold value.

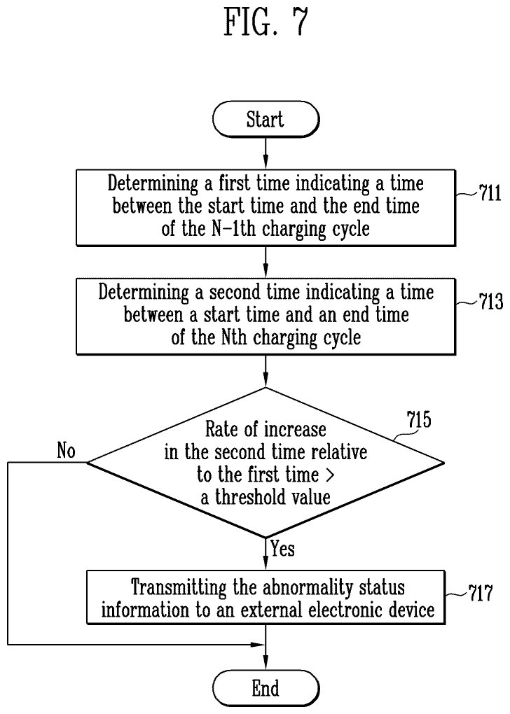

FIG. 7 is a flow diagram illustrating how a charging and discharging device according to the present disclosure detects an abnormality of a battery cell based on a start time and an end time of a charging cycle.

According to one embodiment, referring to FIG. 7, in operation 711, the charging and discharging device 101 may determine a first time indicating a time between the start time and the end time of the N−1th charging cycle. For example, the first time may be indicating a time between a start time of the constant voltage mode included in the N−1thst charging cycle and an end time of the constant voltage mode.

According to one embodiment, in operation 713, the charging and discharging device 101 may determine a second time indicating a time between a start time and an end time of the Nth charging cycle. For example, the second time may indicate a time between a start time of the constant voltage mode included in the Nth charging cycle and an end time of the constant voltage mode.

According to one embodiment, in operation 715, the charging and discharging device 101 may determine whether the rate of increase in the second time relative to the first time is greater than a threshold value. For example, the threshold may be 5, but the number set as the threshold may not be limited thereto. The threshold value may indicate a value associated with a rate value which a battery cell is determined to be abnormal. The threshold value may be set by a user, or may be set automatically by the charging and discharging device 101 (e.g., the controller 120).

According to one embodiment, a rate of increase (%) in the second time period relative to the first time period may be defined by Equation 2 below.

$$rate = \frac{second time period - first time period}{first time period} \times 100 \qquad [ Equation 2 ]$$

According to one embodiment, in operation 717, the charging and discharging device 101 may transmit the abnormality status information of the battery cell to the external electronic device 102 via the communicating portion 190 when the ratio of the second time increase over the first time is determined to be greater than the threshold (“Yes” in operation 715). According to one embodiment, the charging and discharging device 101 may stop charging and discharging operations of the battery cell when it is determined that the rate of the increase of the second time to the first time is greater than a threshold value.

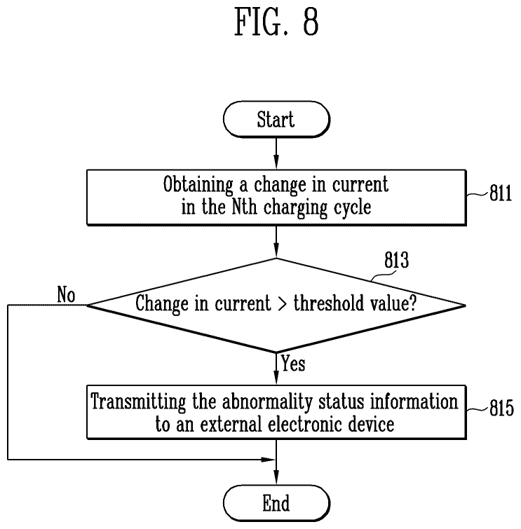

FIG. 8 is a flow diagram illustrating how a charging and discharging device according to the present disclosure detects an abnormality of a battery cell based on a change in current.

According to one embodiment, referring to FIG. 8, in operation 811, the charging and discharging device 101 may obtain the change in current in the Nth charging cycle. For example, the charging and discharging device 101 may obtain the change in current during a specified time in the constant voltage mode of the Nth charging cycle. For example, the specified time may be 3 seconds.

According to one embodiment, in operation 813, the charging and discharging device 101 may determine whether a change in current is greater than a threshold value. For example, the threshold value may be 0.12. The threshold value may indicate a value that is determined to be a rapid change in current in the constant voltage mode of the charging cycle.

According to one embodiment, in operation 815, when the charging and discharging device 101 determines that the change in current is greater than the threshold value (“Yes” in operation 813), the charging and discharging device 101 may transmit the abnormality status information of the battery cell to the external electronic device 102 via the communicating portion 190. According to one embodiment, the charging and discharging device 101 may stop charging and discharging operations of the battery cell when the change in current is determined to be greater than a threshold value.

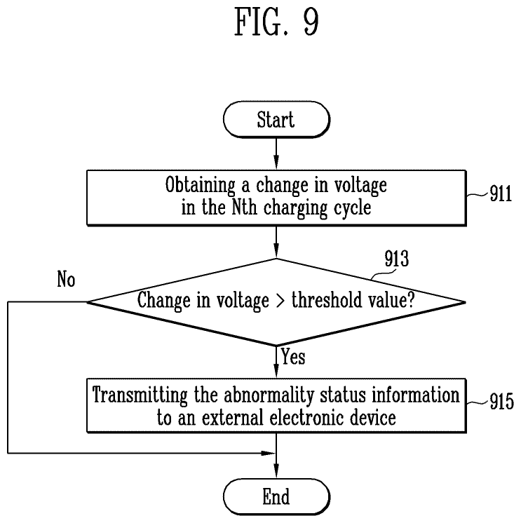

FIG. 9 is a flow diagram illustrating how a charging and discharging device according to the present disclosure detects an abnormality of a battery cell based on a change in voltage of the battery cell.

According to one embodiment, referring to FIG. 9, in operation 911, the charging and discharging device 101 may obtain the change in voltage in the Nth charging cycle. According to one embodiment, the charging and discharging device 101 may obtain the change in voltage over a specified time in the Nth charging cycle. For example, the specified time may be 0.1 seconds.

According to one embodiment, in operation 913, the charging and discharging device 101 may determine whether the change in voltage is greater than a threshold value. The threshold value may indicate a value that is determined to be a rapid change in voltage in a charging cycle. For example, the threshold value may be 200×10⁻³. However, this is an example, and the threshold value of the present disclosure may be set at various values.

According to one embodiment, in operation 915, when the charging and discharging device 101 determines that the change in voltage is greater than the threshold (“Yes” in operation 913), the charging and discharging device 101 may transmit the abnormality status information of the battery cell to the external electronic device 102.

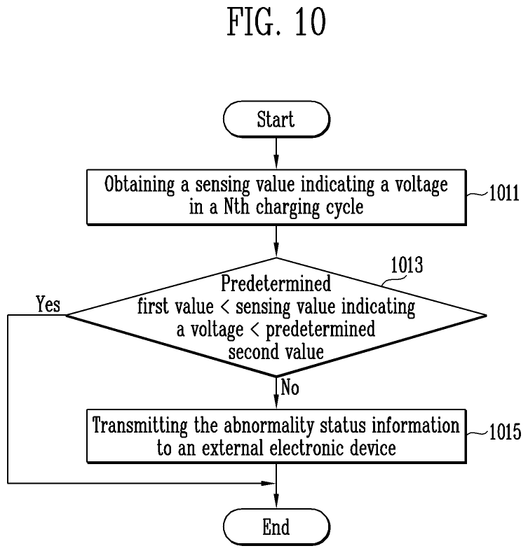

FIG. 10 is a flow diagram illustrating how a charging and discharging device according to the present disclosure detects an abnormality of a battery cell based on a voltage of the battery cell.

According to one embodiment, referring to FIG. 10, in operation 1011, the charging and discharging device 101 may obtain a sensing value indicating a voltage in a Nth charging cycle.

According to one embodiment, in operation 1013, the charging and discharging device 101 may determine whether the sensing value indicating the voltage is between a predetermined first value and a predetermined second value. The predetermined second value may indicate a value greater than the predetermined first value. The predetermined first value may indicate a lower limit value for the voltage at which the battery cell is determined to be normal, and the predetermined second value may indicate an upper limit value for the voltage at which the battery cell is determined to be normal. For example, the predetermined first value may indicate 1.9 and the predetermined second value may indicate 4.4. The predetermined first value and the predetermined second value may be set by a user, set automatically by the charging and discharging device 101 (e.g., the controller 120), or set during the manufacturing of the charging and discharging device 101.

According to one embodiment, in operation 1015, if the charging and discharging device 101 determines that the sensing value indicating the voltage is not between the predetermined first value and the predetermined second value (“No” in operation 1013), the charging and discharging device 101 may transmit the abnormality status information of the battery cell to the external electronic device 102. According to one embodiment, the charging and discharging device 101 may stop charging and discharging operations of the battery cell when it is determined that the sensing value indicating the voltage is not included between the predetermined first value and the predetermined second value.

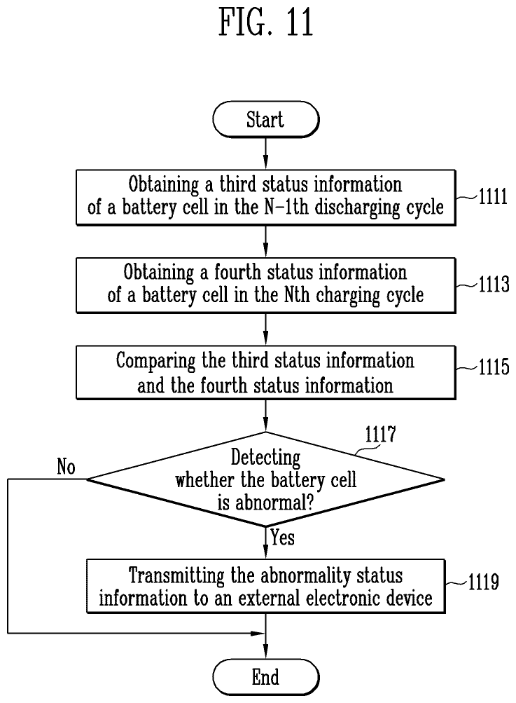

FIG. 11 is a flow diagram illustrating how a charging and discharging device according to the present disclosure detects an abnormality of a battery cell based on status information of the battery cell obtained in a discharging cycle.

According to one embodiment, referring to FIG. 11, in operation 1111, the charging and discharging device 101 may obtain a third status information of the battery cell in the N-1th discharging cycle via the sensing portion 110. According to one embodiment, N may represent a natural number of 2 or more. For example, the third status information may include a sensing value for any one of voltage, current, temperature, or capacity of the battery cell.

According to one embodiment, in operation 1113, the charging and discharging device 101 may obtain, via the sensing portion 110, a fourth status information of the battery cell in the Nth charging cycle. For example, the fourth status information may include sensing values for any one of voltage, current, temperature, or capacity of the battery cell. According to one embodiment, in operation 1115, the charging and discharging

device 101 may compare the third status information and the fourth status information.

According to one embodiment, in operation 1117, the charging and discharging device 101 may determine whether the battery cell is abnormal based on comparing the third status information and the fourth status information. For example, the charging and discharging device 101 may determine whether the battery cell is abnormal based on a difference between a third sensing value included in the third status information and a fourth sensing value included in the fourth status information. For example, the charging and discharging device 101 may determine whether the battery cell is abnormal based on a rate of increase in the fourth sensing value included in the fourth status information relative to the third sensing value included in the third status information.

According to one embodiment, in operation 1119, if the charging and discharging device 101 determines that an abnormality has been detected in the battery cell (“Yes” in operation 1117), the charging and discharging device 101 may transmit the abnormality status information to the external electronic device 102 via the communicating portion 190. The abnormality status information may include information indicating that a defect or an abnormality has occurred in the battery cell. The abnormality status information may further include a command signal causing the external electronic device 102 to output. According to one embodiment, the charging and discharging device 101 may stop charging and discharging operations of the battery cell upon determining that an abnormality has been detected in the battery cell.

According to one embodiment, the external electronic device 102 may receive the abnormality status information from the charging and discharging device 101 via the communication part 192. According to one embodiment, the external electronic device 102 may output the abnormality status information via the output portion 162. For example, the external electronic device 102 may output the abnormality status information by visual means, audible means, and/or tactile means (e.g., haptic).

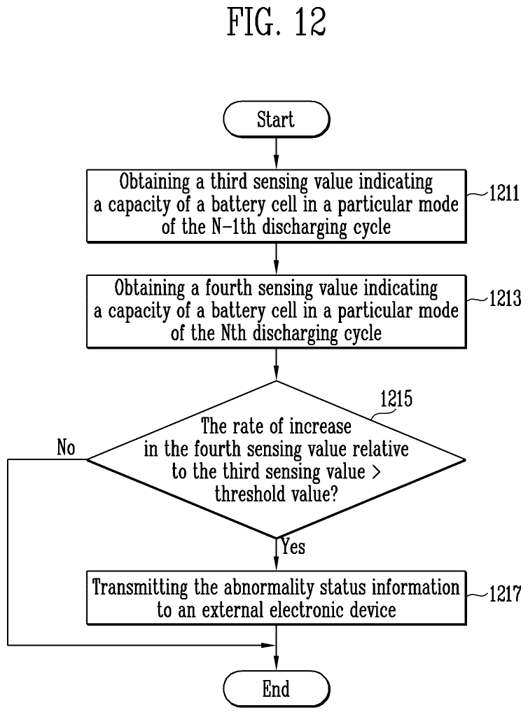

FIG. 12 is a flow diagram illustrating how a charging and discharging device according to the present disclosure detects an abnormality of a battery cell based on a capacity of the battery cell.

According to one embodiment, referring to FIG. 12, in operation 1211, the charging and discharging device 101 may obtain a third sensing value indicating the capacity of the battery cell in a particular mode of the N−1th discharging cycle. For example, the discharging cycle may include a section in a constant current mode. For example, the particular mode may represent a constant current mode. For example, the third sensing value may be indicating the capacity of the battery cell obtained during the section of the constant current mode of the N−1th discharging cycle.

According to one embodiment, in operation 1213, the charging and discharging device 101 may obtain a fourth sensing value indicating the capacity of the battery cell in a particular mode of the Nth discharging cycle. For example, the fourth sensing value may be indicating the capacity of the battery cell obtained during a section of the constant current mode of the Nth discharging cycle.

According to one embodiment, in operation 1215, the charging and discharging device 101 may determine whether the rate of increase in the fourth sensing value relative to the third sensing value is greater than a threshold value. For example, the threshold value may be 5, but the number set as the threshold value may not be limited. The threshold value may indicate a value associated with a rate value which a battery cell is determined to be abnormal. The threshold value may be set by a user, automatically set by the charging and discharging device 101 (e.g., the controller 120), or set during the manufacturing of the charging and discharging device 101.

According to one embodiment, the rate (%) by which the fourth sensing value is increased relative to the third sensing value may be defined by Equation 3 below.

$$rate = \frac{fourth sensing value - third sensing value}{third sensing value} \times 100 \qquad [ Equation 3 ]$$

According to one embodiment, the charging and discharging device 101 may transmit the abnormality status information of the battery cell to the external electronic device 102 via the communicating portion 190 in operation 1217 when it is determined that the rate by which the fourth sensing value is increased relative to the third sensing value is greater than a threshold value (“Yes” in operation 1215).

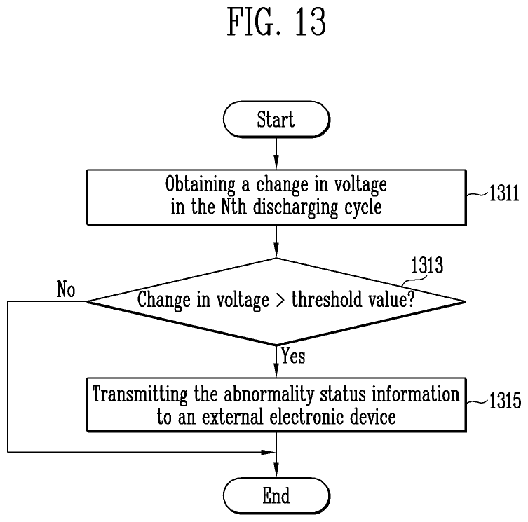

FIG. 13 is a flow diagram illustrating how a charging and discharging device according to the present disclosure detects an abnormality of a battery cell based on a change in voltage of the battery cell.

According to one embodiment, referring to FIG. 13, in operation 1311, the charging and discharging device 101 may obtain the change in voltage in the Nth discharging cycle. According to one embodiment, the charging and discharging device 101 may obtain the change in voltage over a specified time in the Nth discharging cycle. For example, the specified time may be 0.1 seconds. However, this is an example, and the specified time may be set to various values.

According to one embodiment, in operation 1313, the charging and discharging device 101 may determine whether the change in voltage is greater than a threshold value. The threshold value may indicate a value that is determined to be a rapid change in voltage in a discharging cycle. For example, the threshold may be 200×10⁻³. However, this is an example, and thresholds of the present disclosure may be set at various values.

According to one embodiment, in operation 1315, when the charging and discharging device 101 determines that the change in voltage is greater than the threshold (“Yes” in operation 1313), the charging and discharging device 101 may transmit the abnormality status information of the battery cell to the external electronic device 102.

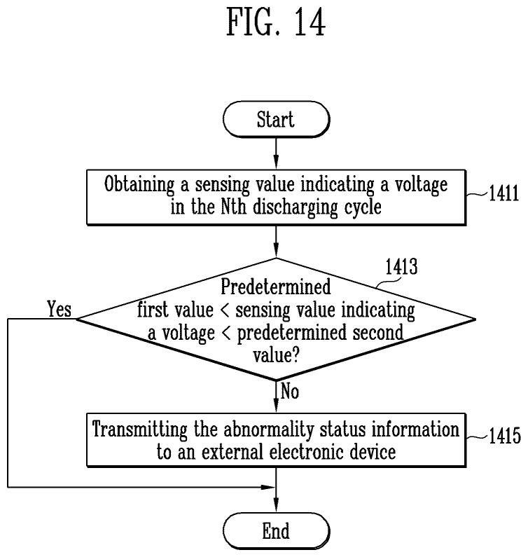

FIG. 14 is a flow diagram illustrating how a charging and discharging device according to the present disclosure detects an abnormality of a battery cell based on a voltage of the battery cell.

According to one embodiment, referring to FIG. 14, in operation 1411, the charging and discharging device 101 may obtain a sensing value indicating a voltage in the Nth discharging cycle.

According to one embodiment, in operation 1413, the charging and discharging device 101 may determine whether the sensing value indicating the voltage is between a predetermined first value and a predetermined second value. The predetermined second value may indicate a value greater than the predetermined first value. The predetermined first value may indicate a lower limit value for the voltage at which the battery cell is determined to be normal, and the predetermined second value may indicate an upper limit value for the voltage at which the battery cell is determined to be normal. For example, the predetermined first value may indicate 1.9 and the predetermined second value may indicate 4.4. The predetermined first value and the predetermined second value may be set by a user, automatically set by the charging and discharging device 101 (e.g., the controller 120), or set during the manufacturing of the charging and discharging device 101.

According to one embodiment, in operation 1415, if the charging and discharging device 101 determines that the sensing value indicating the voltage is not included between the predetermined first value and the predetermined second value (“No” in operation 1413), the charging and discharging device 101 may transmit the abnormality status information of the battery cell to the external electronic device 102. According to one embodiment, the charging and discharging device 101 may stop charging and discharging operations of the battery cell when it is determined that the sensing value indicating the voltage is not included between the predetermined first value and the predetermined second value.

The present disclosure may be practiced in various forms, and the scope of the present disclosure is not limited to the above-described embodiments. Therefore, if the modified embodiments include components of the patent claims of the present disclosure, they should be considered to fall within the scope of the present disclosure.

What is claimed is:

1. A charging and discharging device comprising:
a sensing portion obtaining a status information of a battery cell; and
a controller determining whether the battery cell is abnormal using the status information,
wherein the controller determines whether the battery cell is abnormal based on comparing a first status information of the battery cell obtained in the N−1th, where N is a natural number of 2 or more, charging cycle of the battery cell and a second status information of the battery cell obtained in the Nth charging cycle following the N−1th charging cycle of the battery cell.

2. The charging and discharging device according to claim 1, wherein the first status information includes a first sensing value for at least one of voltage, current, temperature, or capacity of the battery cell, and the second status information includes a second sensing value for at least one of voltage, current, temperature, or capacity of the battery cell.

3. The charging and discharging device according to claim 2, wherein the controller determines whether the battery cell is abnormal based on comparing the first sensing value indicating the highest temperature of the battery cell obtained in the N−1th charging cycle and the second sensing value indicating the highest temperature of the battery cell obtained in the Nth charging cycle.

4. The charging and discharging device according to claim 2, wherein each of the N−1th charging cycle and the Nth charging cycle includes a section based on a constant current mode and a section based on a constant voltage mode.

5. The charging and discharging device according to claim 4, wherein the controller determines whether the battery cell is abnormal based on comparing the first sensing value indicating the capacity of the battery cell obtained in the section based on the constant current mode during the N−1th charging cycle and the second sensing value indicating the capacity of the battery cell obtained in the section based on the constant current mode during the Nth charging cycle.

6. The charging and discharging device according to claim 4, wherein the controller determines whether the battery cell is abnormal based on comparing the first sensing value indicating the capacity of the battery cell obtained in the section based on the constant voltage mode during the N−1th charging cycle and the second sensing value indicating the capacity of the battery cell obtained in the section based on the constant voltage mode during the Nth charging cycle.

7. The charging and discharging device according to claim 4, wherein the controller determines whether the battery cell is abnormal based on comparing a first time indicating a time between the start time and the end time of the section based on the constant voltage mode during the N−1th charging cycle and a second time indicating a time between the start time and the end time of the section based on the constant voltage mode during the Nth charging cycle.

8. The charging and discharging device according to claim 4, wherein the controller determines whether the battery cell is abnormal based on comparing the first sensing value indicating the highest temperature of the battery cell obtained in the section based on the constant current mode during the N−1th charging cycle and the second sensing value indicating the highest temperature of the battery cell obtained in the section based on the constant current mode during the Nth charging cycle.

9. The charging and discharging device according to claim 4, wherein the controller determines whether the battery cell is abnormal based on a change in current of the battery cell obtained in the section based on the constant current mode during the Nth charging cycle.

10. The charging and discharging device according to claim 2, wherein the controller determines whether the battery cell is abnormal based on a change in voltage of the battery cell obtained in the Nth charging cycle.

11. The charging and discharging device according to claim 2, wherein the controller determines that the battery cell is abnormal if the second sensing value indicating the voltage of the battery cell obtained in the Nth charging cycle is not included in a value between a predetermined first value and a predetermined second value greater than the predetermined first value.

12. The charging and discharging device according to claim 1, further comprising: a communicating portion transmitting information indicating an abnormality in the battery cell to an external electronic device, and
wherein the controller, if it determines that the battery cell is abnormal, transmits a control signal to the external electronic device via the communicating portion, causing the external electronic device to output information indicating that the battery cell is abnormal.

13. A charging and discharging device comprising:
a sensing portion obtaining a status information of a battery cell; and
a controller determining whether the battery cell is abnormal using the status information,
wherein the controller determines whether the battery cell is abnormal based on comparing a third status information of the battery cell obtained in the N−1th, where N is a natural number of 2 or more, discharging cycle of the battery cell and a fourth status information of the battery cell obtained in the Nth discharging cycle following the N−1th discharging cycle of the battery cell.

14. The charging and discharging device according to claim 13, wherein the controller determines whether the battery cell is abnormal based on comparing a third sensing value indicating a capacity of the battery cell obtained in a section based on the constant current mode during the N−1th discharging cycle and a fourth sensing value indicating a capacity of the battery cell obtained in a section based on the constant current mode during the Nth charging cycle.

15. The charging and discharging device according to claim 13, wherein the controller determines whether the battery cell is abnormal based on a change in voltage of the battery cell obtained in the Nth discharging cycle.
